(19) United States
(12) Patent Application Publication
(10) Pub. No.: US 2014/0128782 A1
(43) Pub. Date: May 8, 2014

(54) Passive Standing Apparatus

(71) Applicants: Zack Andrew Williamson, III, Louise, TX (US); Garett Lang Williamson, Houston, TX (US)

(72) Inventors: Zack Andrew Williamson, III, Louise, TX (US); Garett Lang Williamson, Houston, TX (US)

(21) Appl. No.: 13/848,695

(22) Filed: Mar. 21, 2013

Related U.S. Application Data
(60) Provisional application No. 61/643,247, filed on May 5, 2012.

(51) Int. Cl. A61H 1/00

(52) U.S. Cl. CPC A61H 1/00
USPC 601/23

(57) ABSTRACT

This is an apparatus used to support a paretic or paraplegic user in a standing position. The apparatus includes a top tubular frame supported by a plurality of vertical tubular members attached to a base. The top frame is open at the front such that a user may position a wheelchair at the opening, in close proximity to the apparatus, and transfer from the wheelchair to the apparatus. The apparatus further includes flexible straps attachable to the two vertical tubular members nearest the opening of the frame. The flexible straps, after having been positioned in strategic locations along the user's lower limbs, function to maintain the user in a standing position. The apparatus further includes a positionable attachable table that augments a user's ability to perform other tasks while standing. The apparatus further includes a wedge upon which the user may stand to maintain dorsiflexed feet position.

### CROSS-REFERENCE TO RELATED APPLICATIONS

This application claims the benefit of U.S. Provisional Application No. 61/643,247, filed May 5, 2012.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

This invention relates generally to a stand used to support a paretic or paraplegic individual in an upright position to minimize or mitigate the deteriorative effects of prolonged sitting or recumbent positioning.

2. Description of Prior Art

There are numerous devices that can be used to assist a paretic or paraplegic individual attain a standing position. Some of these devices have methods to raise a wheel chair system into a standing position. Other devices have lifting mechanisms to move a user from a sitting position into a standing position. Other devices are used as a combination of a standing device and a mobile device such that a user can be positioned into a standing position and, under the power of the user's legs, move the standing device from one location to another.

U.S. Pat. No. 4,279,043 discloses a type of device that can assist paraplegics to stand. The base of this device is supported by casters, allowing the device to be moveable. It is a primary object of the current invention to provide a standing apparatus mounted to a rigid, secure base so that the possibility of a paraplegic individual to fall is unlikely.

U.S. Pat. No. 4,111,445 also discloses a type of standing device for paraplegics that allows the user to move about, having the base of the device mounted on casters.

U.S. Pat. Nos. 4,290,423 and 5,484,151 and 8,302,221 each disclose a type of device to assist paraplegics to stand, including lift mechanisms to raise an individual from a wheel chair to the standing device. Various embodiments of the devices are also mounted on casters or wheels, allowing the base to be moveable. Another object of the current invention is to provide a standing apparatus for paretic and paraplegic individuals that is uncomplicated to use, requiring neither the use of a lifting mechanism nor casters or wheels to lock in order to render the base of the device relatively immobile.

U.S. Pat. No. 5,884,935 discloses a type of standing device with various configurations including a lifting mechanism to assist a user to transfer from the sitting position to the standing position and casters on the base to enable the device to be somewhat mobile. Again, objects of the current invention are to provide a standing apparatus securely mounted to a relatively immobile base and to provide an uncomplicated device that has few moving parts and is relatively simple to utilize.

U.S. Pat. No. 4,314,576 discloses a device for assisting paraplegics to stand and walk. An object of the current invention is to provide a standing apparatus that permits a paretic or paraplegic individual to move his upper torso in a lateral, posterior, and anterior direction but restrict significant movement of the legs, thus minimizing the possibility of an unstable standing position.

U.S. Pat. No. 7,632,223 discloses a device for enabling an individual to stand utilizing a baseboard upon which the user is strapped. The user of this device is required to either approach the device head-on and thence rotate his body 180 degrees or be placed against the backboard with assistance from other individuals in order to be effectively secured to the backboard. An object of the current invention is to provide a standing apparatus that allows the user to approach the apparatus in a wheel chair, position the wheel chair appropriately close to the apparatus, and transfer into a standing position directly from the position of sitting in a wheel chair.

An object of the current invention is to provide an apparatus for standing that is very stable, providing a high level of safety for the user. Many of the other standing devices available are mounted on casters, creating the possibility of undesirable movement of the device.

Another object of the current invention is to provide an apparatus for standing that is uncomplicated to partially disassemble in order for it to be transported. Many of the other standing devices available are complicated to partially disassemble and are not easily transportable.

Another object of the current invention is to provide an apparatus for standing that utilizes a removable table surface such that ancillary objects such as food, drinks, books, computers, etc., may be placed upon the table surface for access by the user.

Another object of the current invention is to provide an apparatus for standing that places the user's feet in the dorsiflexed position, a proven therapeutic advantage over standing with the user's feet in the normal, anatomical position.

### SUMMARY OF THE INVENTION

Briefly described, the invention provides a passive standing frame wherein a person suffering from paresis, paraplegia or other form of temporary or permanent loss of use of the lower limbs may stand upright in order to benefit both physiologically and psychologically from such a position. Much research evidence exists documenting therapeutic benefits gained from maintaining a standing position (Axelson et al., 1987; Nyquist, 1962).

One of the greatest benefits from standing is the prevention or minimization of hypercalciuria, an elevation of calcium in the urine, which is an indication of bone de-mineralization and a common problem for both paraplegics and paretics. (Abramson, 1948; Abramson & Delagi, 1961; Comarr, 1955; Hattner & McMillan, 1968; Kaplan et al., 1981).

Standing also reduces both the incidence and severity of lower limb spasticity (Odeen & Knuttson, 1981).

There is also a reduction in the occurrence of pathological fractures when standing is included as part of therapy for individuals suffering from lower limb paralysis (Abramson, 1948; Abramson & Delagi, 1961; Comarr, 1955; Hattner & McMillan, 1968; Kaplan et al., 1981).

Standing improves orthostatic cardiovascular regulation (Lopes, Figoni & Parkash, 1984; Odeen, 1979).

Improvements to general renal function and specifically to urinary drainage are also realized benefits from standing (Gould et al., 1955).

Standing also provides relief from and prevention of pressure sores on seated weight-bearing areas (Abramson & Ebel, 1953).

Another primary benefit gained from standing by persons with some form of lower limb paralysis is improvement to functional status and morale. The ability to perform tasks while concurrently standing has been shown to have significant, positive psychological effects on those bedridden or wheel chair bound.

The invention provides for a rigid tubular frame attached to a base and having an opening at the front and the frame such that a person in a wheel chair may position the wheel chair within the opening and in close proximity to the frame. The rigid tubular frame contains two parallel and horizontal handrails attached by cross members such that, as mentioned above, an opening is formed at the front of the frame. A person, having properly positioned a wheel chair, may then secure his heels and upper shins against straps attached to the frame and, with or without the assistance of an aid, raise himself into the standing position. Once in the standing position, another strap secures the person's lower torso, across the hip area, within the frame such that the person is able to maintain a standing position, supported by the straps attached to the frame.

In one embodiment of the invention, a wedge is provided for the user to stand upon, the use of which is intended to elevate the user's toes above his heels, placing the user's feet in the dorsiflexed position. The dorsiflexed foot position promotes muscle stretching, a physiological benefit to users.

In another embodiment of the invention, a rigid table is provided to be easily positionable and attachable to the handrails of the frame so that the user may position objects upon the table for use in performing tasks.

### BRIEF DESCRIPTION OF THE DRAWINGS

FIG. 1 is a perspective view of the passive standing apparatus of this invention as viewed from the top, left and front.

FIG. 2 is a left-side elevation view of the device of FIG. 1.

FIG. 3 is a front elevation view of the device of FIG. 1.

FIG. 4 is a perspective view of a table member used in the device of FIG. 1 and useful in depicting the attachment method of said table member as viewed from the top, left and front.

FIG. 5 is a front elevation view of a table member used in the device of FIG. 1 and useful in depicting the attachment method of said table.

FIG. 6 is a perspective view, including exploded view, of a wedge used in the device of FIG. 1 as viewed from the top, left and front.

FIGS. 7-10 are perspective views of various components used in constructing the device of FIG. 1.

FIG. 11 is a front elevation view of a flexible strap used in the device of FIG. 1.

FIG. 12 is a perspective view of a section of the passive standing apparatus of this invention as viewed from the top, left and front and depicting a user standing within the device of FIG. 1.

### DESCRIPTION OF THE INVENTION

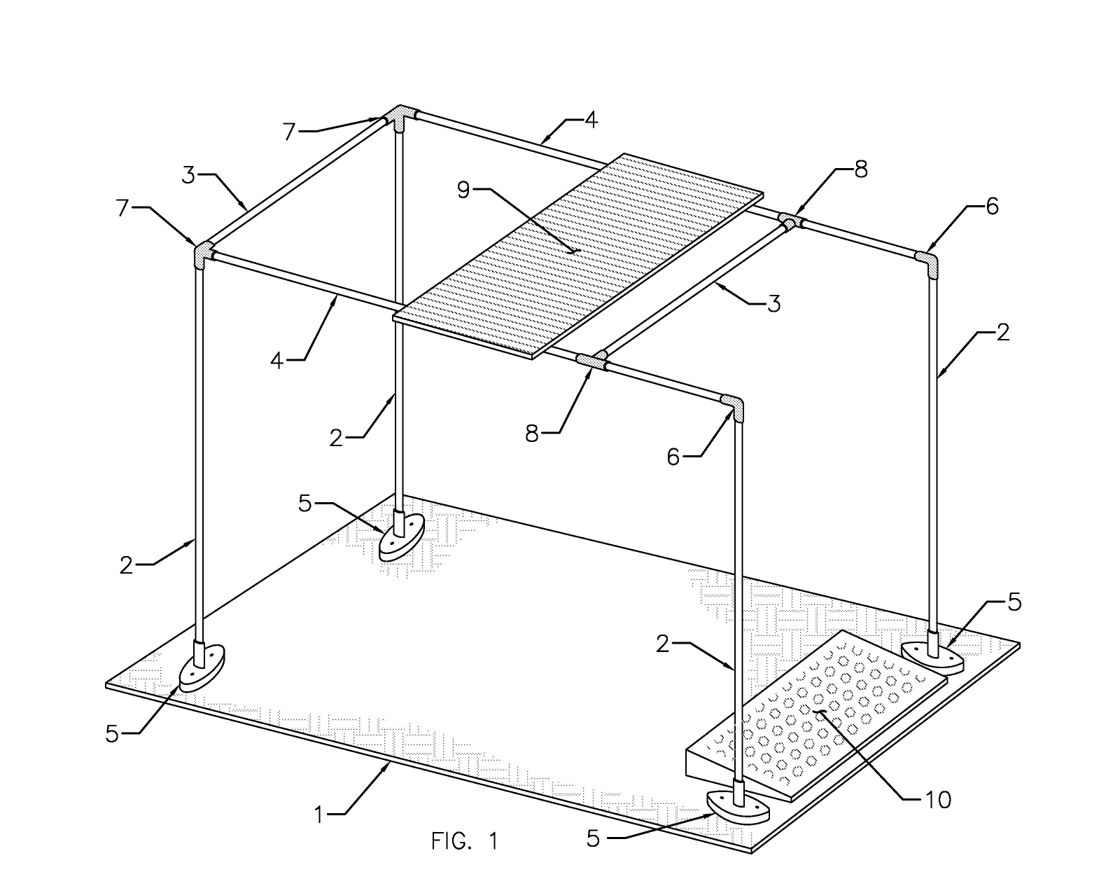

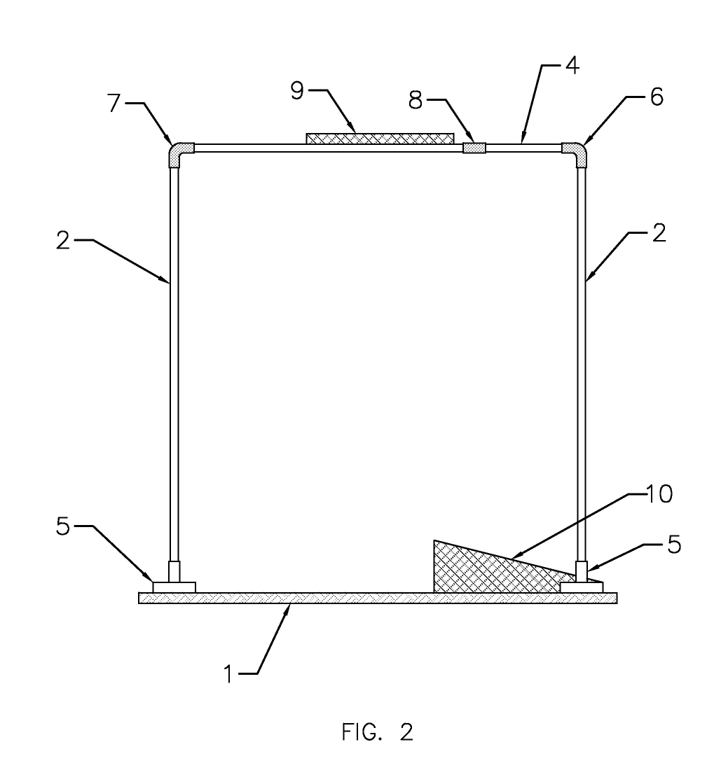

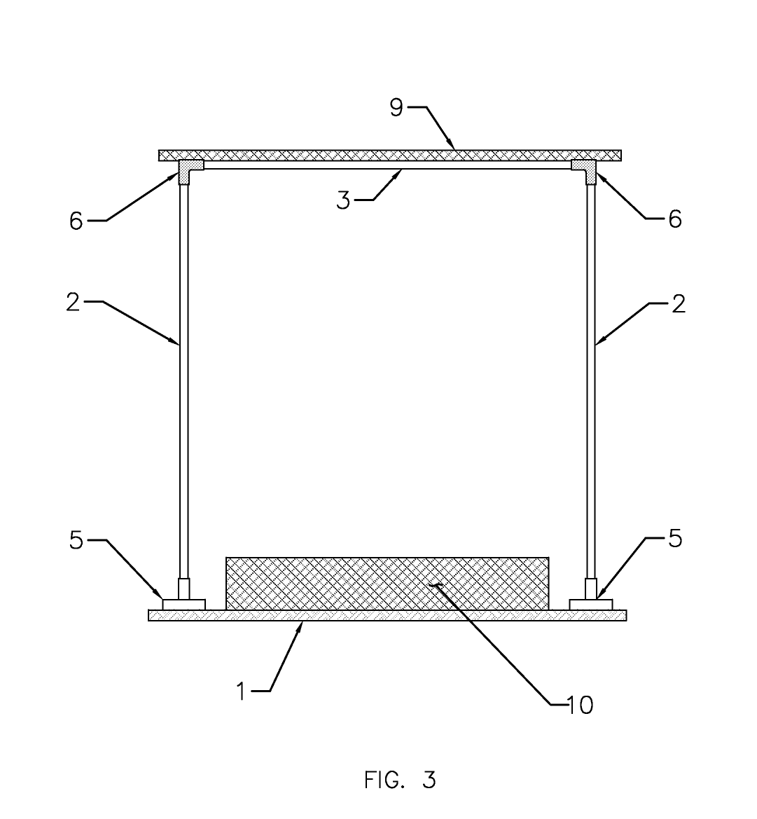

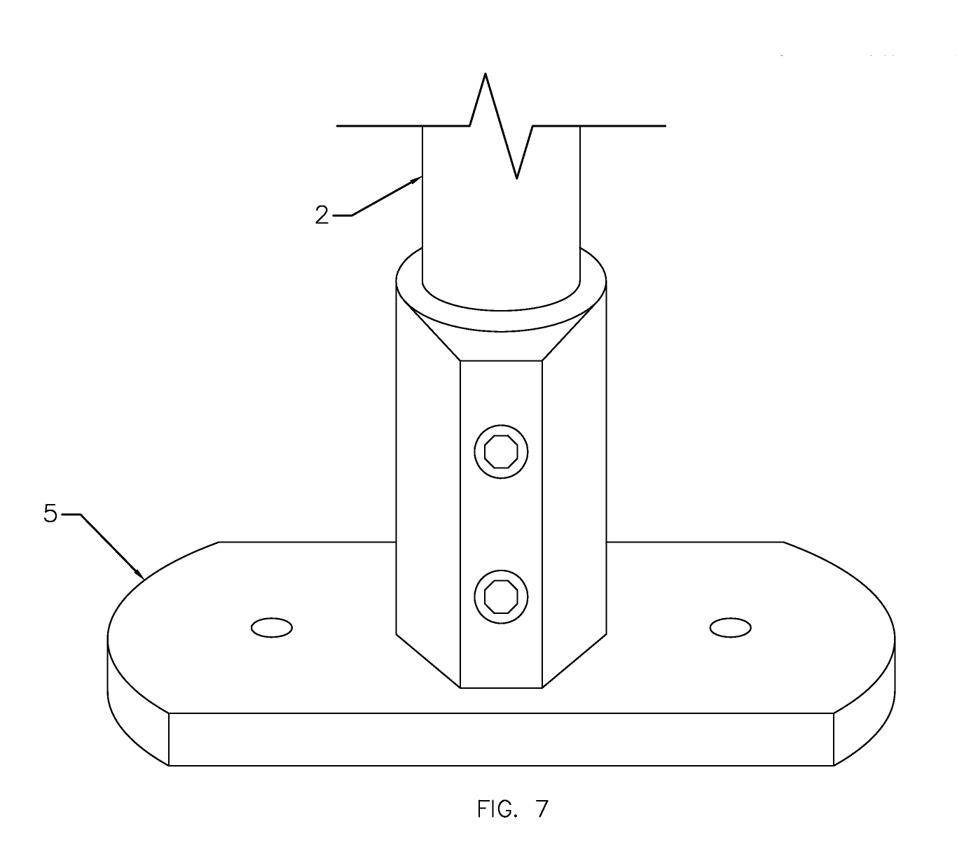

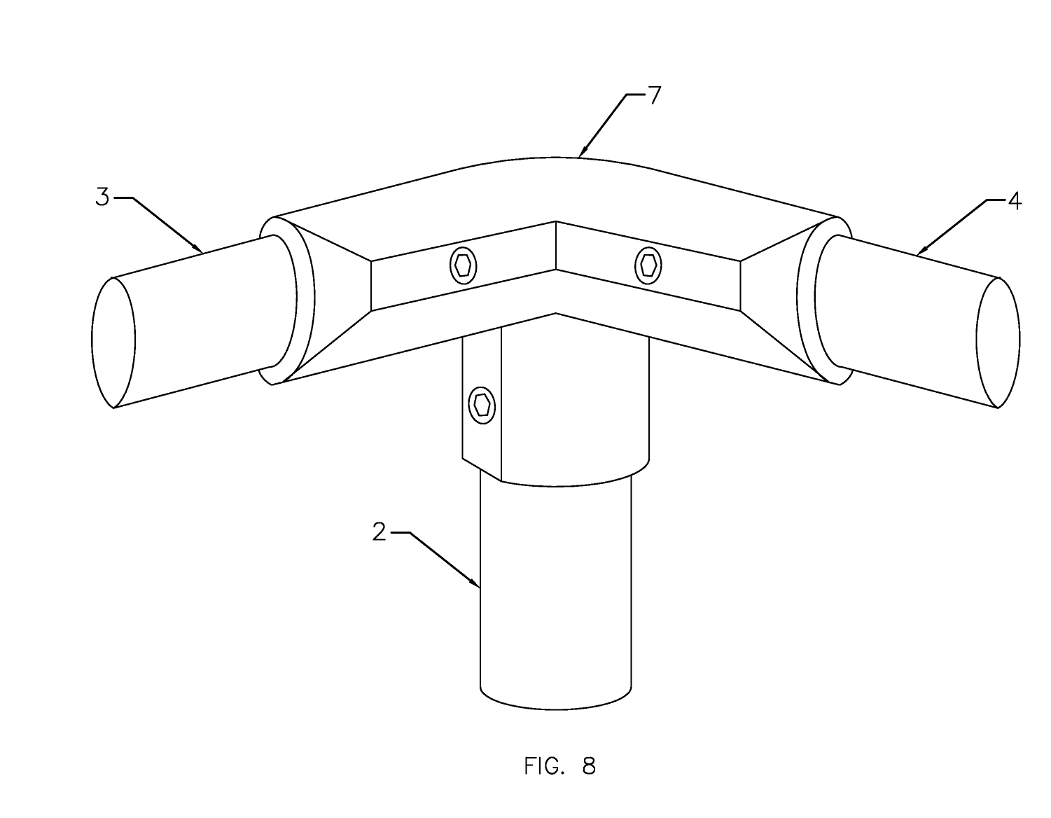

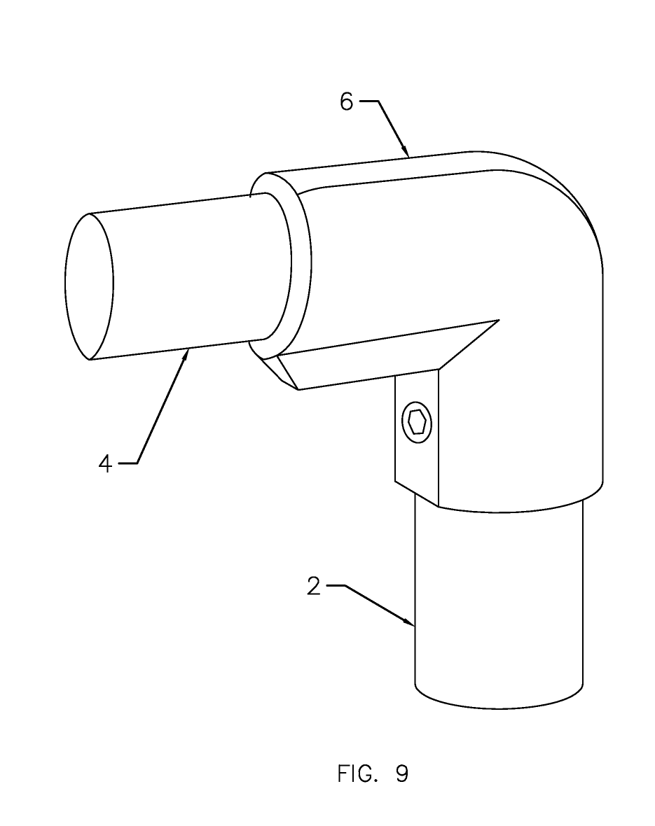

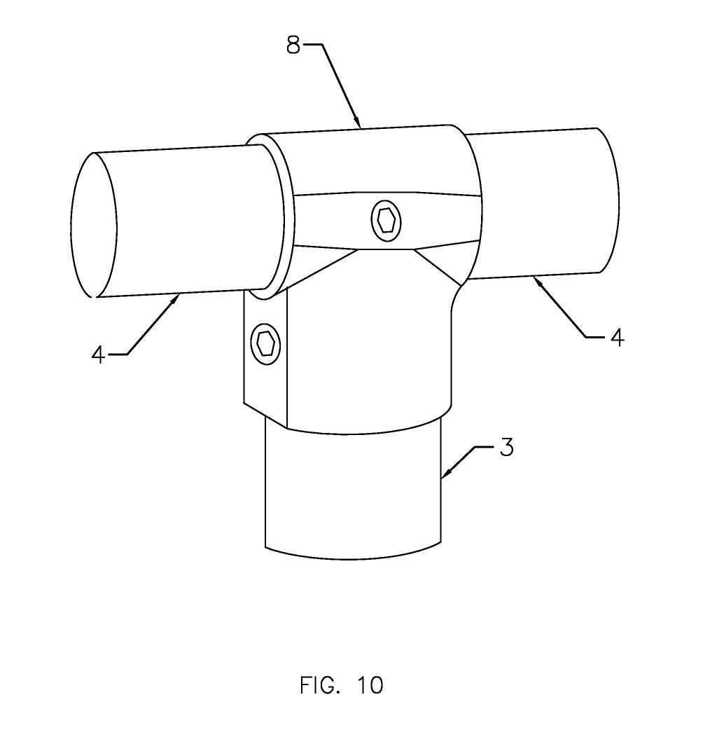

Referring now to the drawings, particularly FIGS. 1-3, a passive standing apparatus includes a rigid tubular top frame attached to a rectangular base 1 by a plurality of vertical rigid tubular legs 2. The top frame attachments to the vertical legs and the vertical legs attachments to the base are provided using rigid slip-on fittings 5, 6, 7, and 8. FIGS. 7-10 further depict these rigid fittings 5, 6, 7, and 8 used as components of the invention. The rigid fittings 5, 6, 7, and 8 are constructed such that the tubular elements of the top frame 3 and 4 and vertical legs 2 fit closely into each rigid fitting and are secured within the fitting by means of one or more hardened, recessed set screws.

The top frame comprises two parallel, horizontal handrails 4, a plurality of horizontal cross members 3 arranged perpendicularly to 4, and rigid fittings 6, 7, and 8. Handrails 4 are rigidly attached at each extremity to a rigid fitting 6 and 7. Rigid fittings 6 are utilized at the front of the frame and rigid fittings 7 are utilized at the rear of the frame. The top frame is generally rectangular to the extent that the horizontal dimension between front rigid fittings 6 and the horizontal dimension between the rear rigid fittings 7 are equal, and the dimension between rigid fittings 6 and 7 are equal on each side of the top frame.

The handrails 4 are further attached to a plurality of perpendicular horizontal cross members 3 such that a cross member 3 is attached to the rear extremity of the handrails 4 with rigid fittings 7 and another cross member 3 is adjustably attached to the handrails 4 with rigid fittings 8.

Cross member 3, attached to rigid fitting 7 is attached to the rear extremity of handrails 4 such that the 90-degree horizontal angles formed by the intersection of handrails 4 and cross member 3 form the rear boundary of the top frame.

Cross member 3, attached to rigid fittings 8, is attached to handrails 4 such that cross member 3 is positioned rearward from the front of the frame sufficiently to construct an opening at the front of the frame. The front-to-back, horizontal dimension of the opening at the front of the frame is adjustable to accommodate the midsection dimensions of users such that the cross member 3 and table 9 may be attached to handrails 4 at a comfortable position for each user. The portion of fitting 8 accommodating and being attached to handrail 4 is a straight-through fitting such that handrail 4 is a continuous unit of rigid tubular material. Rigid fittings 8, attached to cross member 3, may be manipulated and positioned by a user by loosening a single set screw on each rigid fitting 8.

The rigid tubular top frame comprising 3, 4, 6, 7, and 8 is further attached to a plurality of vertical rigid tubular legs 2. The rear of the top frame is attached to legs 2 at each rigid fitting 7. The front of the top frame is attached to legs 2 at each rigid fitting 6.

Each vertical rigid tubular leg 2 is further attached to a rigid fitting flange 5. The flanges 5 positioned near the rear of the base 1 are arranged in a manner such that the long sides of the flanges 5 are parallel to the shorter side or rear edge of base 1. The flanges 5 positioned near the front of the base, nearer the opening of the frame, are arranged in a manner such that the long sides of the flanges 5 are parallel to the longer side of base 1. Further, the flanges 5 are each solidly attached to the base.

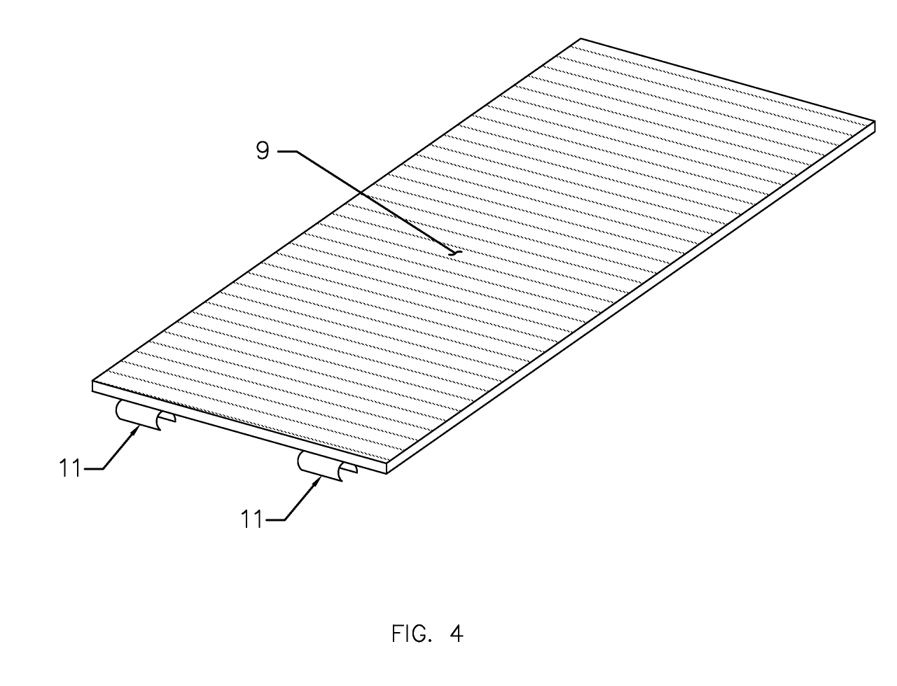

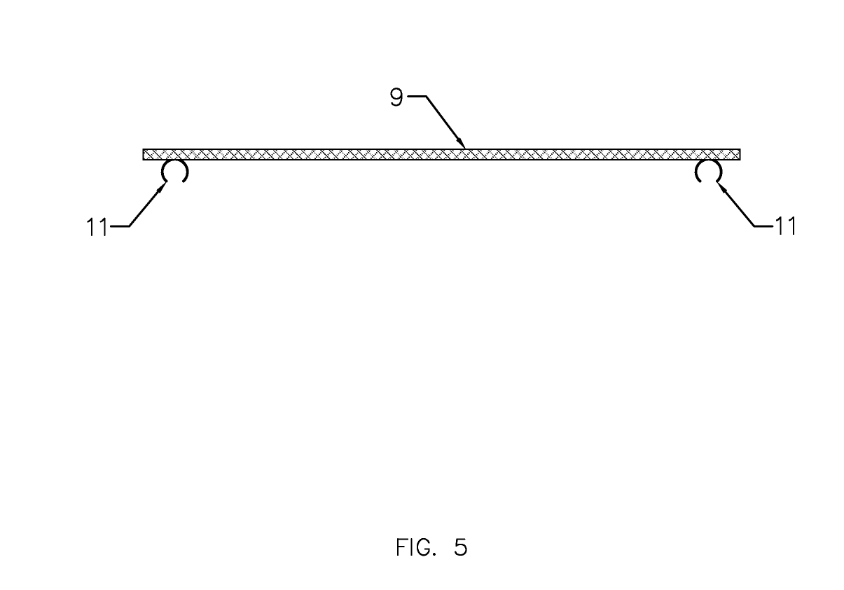

Referring particularly to FIGS. 1, 4, and 5, another embodiment of the invention includes a table 9 that is adjustably attached to handrails 4. A plurality of flexible clips 11, located and attached to the underneath surface of table 9, are arranged to be directly in line and parallel to each handrail 4. Flexible clips 11 are attached to table 9 such that the table 9 may be positioned above the top frame with the longitudinal center line of flexible clips 11 aligned with the longitudinal center line of handrails 4 and pressed downward onto handrails 4, thus making a removable attachment of the table 9 onto handrails 4.

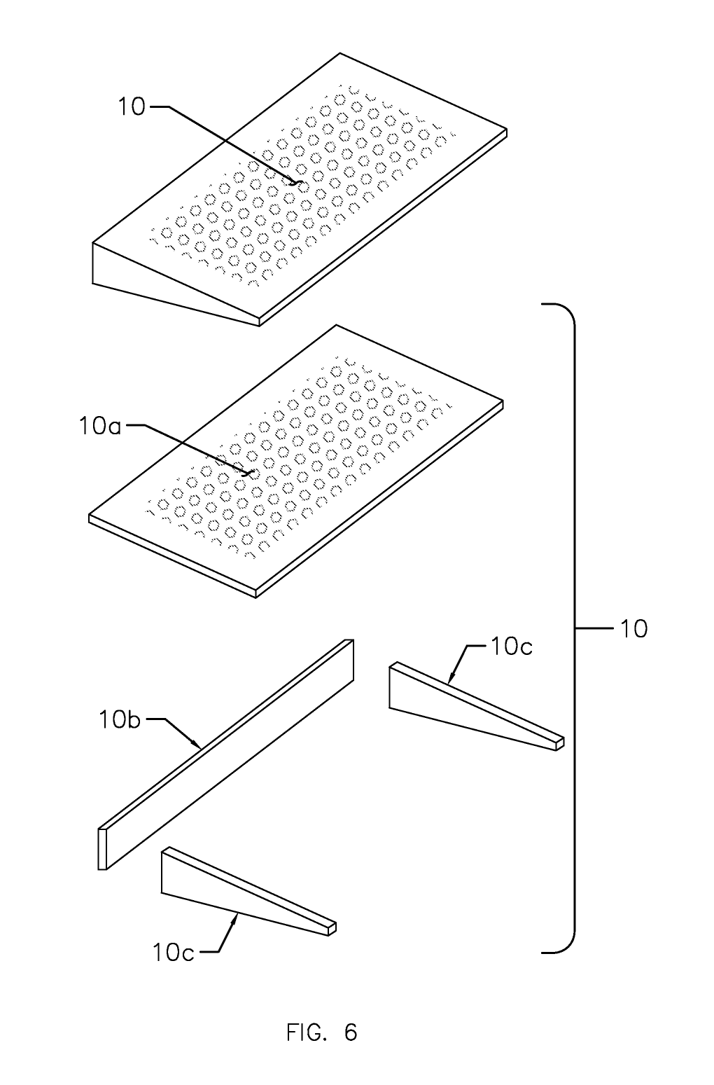

Referring particularly to FIG. 6, another embodiment of the invention includes a wedge 10 upon which users may stand promoting their feet to be dorsiflexed positioned. The wedge 10 comprises a rectangular upper surface attached to a rear bracing element and two side angular elements. The wedge 10 is designed to be arranged on the upper surface of base 1 and within the opening of the top frame such that the user's feet are arranged onto the wedge while the user is in the standing position.

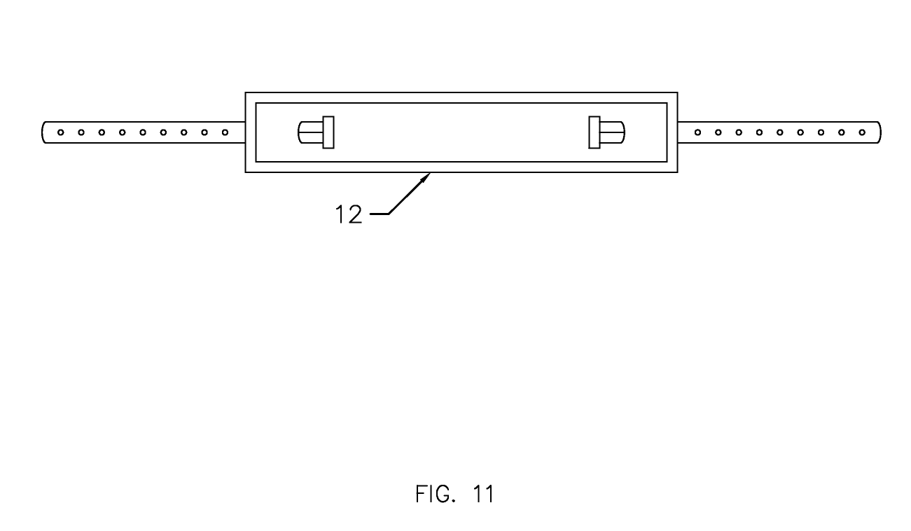

FIG. 11 depicts a flexible strap 12 such that a plurality may be attached to vertical legs 2 at the front of the frame between rigid fittings 5 and 6 and useful in maintaining a therapeutically desired position of a user's lower limbs. Flexible strap 12 is constructed of durable flexible materials such that each end length of the strap 12 may be adjustably attached to a vertical leg 2.

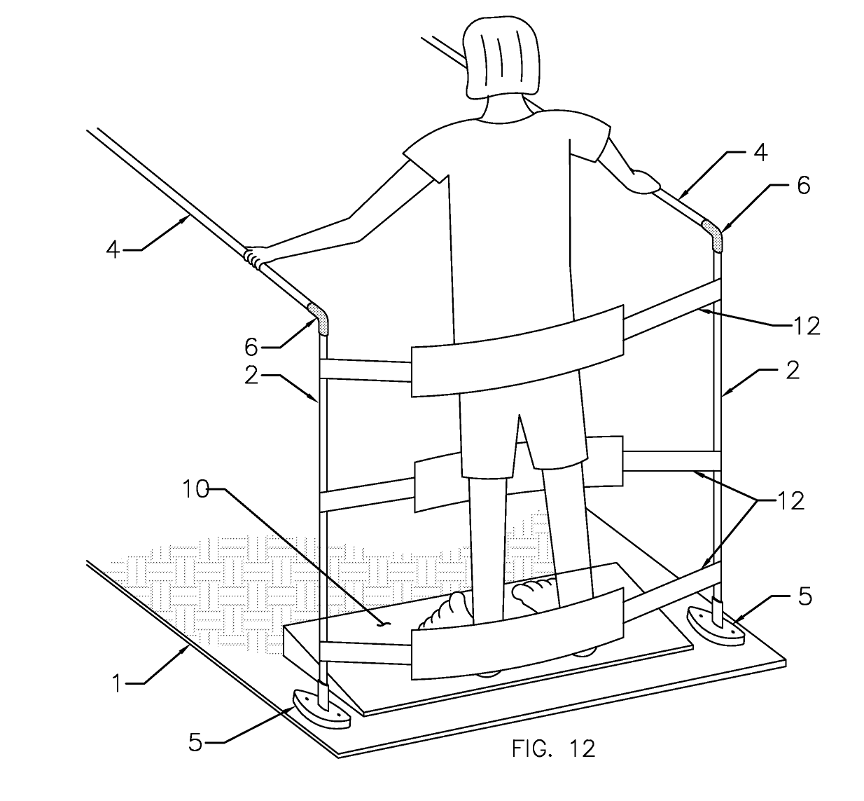

FIG. 12 depicts a user in the standing position and upon a wedge 10. Flexible straps 12 are depicted as arranged behind the heels of the user's feet, on the shin area below the user's knees, and along the hips/buttocks area of the user.

The embodiments of the invention shown and described provide means of providing a user with lower limb mobility limitations or paralysis to maintain a passive standing position such that the user is able to benefit from numerous therapeutic effects, both physiological and psychological. The depicted and described embodiments are not intended to limit the invention, but to illustrate various components that would benefit a user.

I/we claim:

1. An apparatus for supporting a paretic or paraplegic user in a standing position comprising: a horizontally disposed tubular frame, wherein said frame includes an opening at one end to facilitate entry by a user in a wheel chair; vertically disposed tubular members connecting said frame to a base; flexible straps removably connected to opposing vertical tubular members at the open end of said frame and positioned in such a manner as to provide support for maintaining a user's legs in a upright, anatomical position.

2. The apparatus in claim 1 wherein the individual tubular components of said frame and said vertical members are connected to their respective tubular members or said base by means of tubular slip-on fittings such that the end pieces of tubular components are inserted and restrained within their respective tubular slip-on fitting, thus facilitating a method of partial disassembly of the apparatus.

3. The apparatus of claim 1 wherein a wedge is removably connected to said base in such a manner that a user may stand upon said wedge in order to elevate a user's toes above his heels, placing the user's feet in the dorsiflexed position.

4. The apparatus in claim 1 wherein a rigid table is removably connected to said horizontally disposed tubular frame in such a manner that ancillary objects may be placed upon said table and made accessible to a user.
